(19) United States
(12) Patent Application Publication
(10) Pub. No.: US 2010/0292950 A1
(43) Pub. Date: Nov. 18, 2010

(54) RADIATION THERMOMETRY AND RADIATION THERMOMETRY SYSTEM

(75) Inventors: Tohru Iuchi, Machida-shi (JP); Kensuke Hiraka, Toda-Shi (JP)

Correspondence Address: MOTS LAW, PLLC, 1629 K STREET N.W., SUITE 602, WASHINGTON, DC, 20006-1635, US

(73) Assignee: TOYO UNIVERSITY, Tokyo (JP)

(21) Appl. No.: 12/808,754

(22) PCT Filed: Dec. 11, 2008
(86) PCT No.: PCT/JP2008/072518

§ 371 Date: Jun. 17, 2010

(30) Foreign Application Priority Data
Dec. 20, 2007 (JP) 2007-328667

(51) Int. Cl. G06F 15/00; G01K 1/00

(52) U.S. Cl. 702/134

(57) ABSTRACT

With proposed radiation thermometry and radiation thermometry system (10), a thin-film (2) is disposed on a substrate to make a thin-film substrate, and measurement is conducted for polarized radiance components emitted from the thin-film (2) in a direction which is within an angle range θ eic, from a planar normal line of the thin-film (2), where radiance components remain invariable. A temperature of the thin-film (2) is determined on the basis of the measured results of the polarized radiance components. The polarized radiance components are measured using a radiometer (4) by measuring p-wave polarized radiance components which are parallel to an emitting surface including a direction where the polarized radiance components are measured. A pseudo-blackbody (5) is disposed in a mirror symmetrical state to the radiometer (4), and absorbs and negates background radiations to the radiometer (4). Further, temperatures of the pseudo-blackbody (5) are measured, and will be made allowance for calculation of temperatures of the thin-film (2).

### TECHNICAL FIELD

This invention relates to radiation thermometry and a radiation thermometry system, and specifically relates to radiation thermometry for measuring temperatures of a thin-film on a substrate in non-contact state and a system for carrying out such radiation thermometry. Further, the invention relates to effective radiation thermometry in which in-situ temperature measurement is carried out of contact with a thin-film, and an effective system for such radiation thermometry.

### BACKGROUND ART

In a semiconductor device fabricating process, a film making technique by which thin-films such as insulating films, conductive films and so on are deposited on wafers plays a very important role to determine properties of semiconductor devices. Especially, a film depositing temperature (process temperature) of thin-films exerts a considerable influence on solid state properties of thin-films.

A variety of methods are available to measure temperatures of thin-films in semiconductor fabricating processes, e.g. contact temperature measurement in which a thermocouple temperature sensor is brought into contact with thin-films, or a non-contact temperature measurement in which radiation temperature sensor or pyrometer is used out of contact with thin-films For instance, with the contact temperature measurement, the thermocouple temperature sensor is brought into contact with a specimen thin-film, and thermal energy is converted into an electric signal, on the basis of which a temperature of the thin-film can be measured. In the contact temperature measurement, it is necessary to provide a temperature sensor in a film making unit, which will be likely to cause contaminations affecting properties of the thin-films and semiconductor devices.

On the other hand, with the non-contact temperature measurement, thermal emissions (electromagnetic waves including light) of thin-films which are being made or have been made are measured using a radiometer. Temperatures of the thin-films are determined on the basis of the measured results. The radiometer is disposed outside the film making system, which is effective in preventing contaminations resulting from the temperature measurement.

Still, in the temperature measurement, the disclosure has been made on a hybrid surface temperature sensor in the following Patent Document 1. And the disclosure has been made on non-contact temperature sensors in the following Patent Documents 2 and 3.

Citation List

Patent Literature

PLT1: Japanese Laid-open Patent Publication No. 2007-218591

PLT2: Japanese Laid-open Patent Publication No. Hei 10-9958

PLT3: Japanese Laid-open Patent Publication No. Hei 10-281878

### SUMMARY OF INVENTION

### Technical Problem

The foregoing non-contact temperature measurement can prevent the contamination on thin-films, and has been effectively applied to measurement of film making temperatures of thin-films in the silicon semiconductor fabricating process which requires microfabrication. However, it is very difficult to precisely measure temperatures of thin-films since surfaces of substrates have varying degrees of emissivity depending upon thicknesses and materials of thin-films to be made. Further, actual film making temperatures are variable, and tend to adversely affect properties of thin-films, which will deteriorate performance of semiconductor devices.

The invention is contemplated to overcome foregoing problems of the related art, and provides radiation thermometry by which temperatures of thin-films on a substrate can be precisely measured in non-contact state, and a radiation thermometry system.

### Solution to Problem

According to a first feature of the embodiment of the invention, radiation thermometry includes: depositing a thin-film on a substrate and making a thin-film substrate; measuring polarized radiance components emitted from the thin-film substrate in a direction which is within an angle range, from a planar normal line of the thin-film substrate, where radiance components remain invariable; and calculating a temperature of the thin-film substrate on the basis of the measured results of the polarized radiance components.

In the foregoing radiation thermometry, the polarized radiance components are preferably measured by measuring p-wave polarized radiance components which are parallel to an emitting surface including a direction where the polarized radiance components are measured. Further, the polarized radiance components are preferably measured in a wavelength range where the thin-film substrate becomes opaque.

Further, in the foregoing radiation thermometry, it is preferable that the thin-film substrate is made by depositing a silicon oxide thin-film on the substrate, and the p-wave polarized radiance components are measured when p-wave polarized radiance components are present at an angle of 53 degrees to 57 degrees with respect to a normal line of the silicon oxide thin-film substrate, the center angle being 55 degrees. Still further, it is preferable that the thin-film substrate is made by depositing a silicon-nitride thin-film on the substrate, and the p-wave polarized radiance components are measured when p-wave polarized radiance components are present at an angle of 61 degrees to 65 degrees with respect to a normal line of the silicon nitride thin-film substrate, the center angle being 63 degrees. Besides, it is preferable that the thin-film substrate is made by depositing a silicon oxynitride thin-film on the substrate, and the p-wave polarized radiance components are measured when p-wave polarized radiance components are present at an angle of 55 degrees to 59 degrees with respect to a normal line of the silicon oxynitride thin-film substrate, the center angle being 57 degrees.

In accordance with a second feature of the embodiment of the invention, radiation thermometry includes: depositing a thin-film on a substrate and making a thin-film substrate; disposing a pseudo-blackbody on an incident axis in an emitting direction where emissivity of first polarized radiance components emitted by the thin-film substrate do not vary at an angle which is mirror-symmetrical to the normal line of the surface of the thin-film substrate, and measuring temperatures of the pseudo-blackbody, the pseudo-blackbody absorbing and negating background radiations and emitting constant radiance components; measuring not only the first polarized radiance components but also second polarized radiance components emitted from the pseudo-blackbody onto the incident axis and reflected on the surface of the thin-film substrate, the second polarized radiance components being advanced in the emitting direction: and calculating a temperature of the thin-film substrate on the basis of the measured first and second polarized radiance components and the temperature of the pseudo-blackbody.

In accordance with the first or second feature, the radiation thermometry further preferably includes: contacting a thin-film contact shoe with the surface of the thin-film substrate, and measuring radiance emitted from front and rear surfaces of the thin-film contact shoe; and measuring a surface temperature of the thin-film substrate on the basis of the measured polarized radiance components. Further, in the foregoing radiation thermometry, it is preferable that after a first process in which the surface temperature of the thin-film substrate is measured on the basis of radiance emitted from the rear surface of the thin-film contact shoe, and a second process in which the polarized radiance components or the first polarized components are measured within an angle where the emissivity remains invariable from the normal line of the thin-film substrate, and calculating a temperature of the thin-film substrate on the basis of the measured results; determining whether or not the temperature of the thin-film substrate in the first process is within a tolerance range of the measured results when compared with the surface temperature in the second process; and using the second process for the measurement of the surface temperature of the thin-film substrate when the measured value is in a tolerance range.

According to a third feature of the embodiment of the invention, a radiation thermometry system includes: a radiometer measuring polarized radiance components, which are emitted from a thin-film substrate within an angle range where emissivity remains invariable, the thin-film substrate having a thin-film on a surface thereof, and an arithmetic unit calculating a temperature of the thin-film substrate on the basis of the polarized radiance components measured by the radiometer.

It is preferable that the foregoing radiation thermometry system fur includes: a chamber housing the thin-film substrate therein; a heat sources heating the thin-film substrate; and a polarization element disposed between the thin-film substrate and the radiometer, and extracting polarized radiance components emitted by the thin-film substrate.

In accordance with a further feature of the embodiment of the invention, a radiation thermometry system includes: a pseudo-blackbody disposed on an incident axis in an emitting direction at an angle where emissivity of first polarized radiance components emitted by the thin-film substrate do not vary, wherein the pseudo-blackbody absorbs and negates background radiations, and emits constant radiance components, and the incident axis is mirror-symmetrical to the normal line of the surface of the thin -film substrate; a temperature sensor measuring temperatures of the pseudo-blackbody; a radiometer disposed in the emitting direction and measuring not only the first polarized radiance components but also second polarized radiance components emitted from the pseudo-blackbody onto the incident axis and reflected on the surface of the thin-film substrate, the second polarized radiance components being advanced in the emitting direction: and an arithmetic unit calculating a temperature of the thin-film substrate on the basis of the measured first and second polarized radiance components and the temperature of the pseudo-blackbody.

According to third or further feature of the invention, it is preferable that the radiation thermometry system further includes: a contact sensor having a contact thin-film contact shoe brought into contact with a surface of the thin-film substrate; and a sensor measuring polarized radiance components emitted from a rear surface of the thin-film contact shoe of the contact sensor, and sending measured results to the arithmetic unit.

Advantageous Effects of Invention

The invention can provide the radiation thermometry and radiation thermometry system in which temperatures of thin-films on substrates can be precisely measured in a non-contact state.

### BRIEF DESCRIPTION OF DRAWINGS FIG. 1 is a block diagram explaining a first basic principle of radiation thermometry and a radiation thermometry system according to a first example of the invention.

FIG. 2 shows the relationship between p-wave polarized emissivity and emission angles.

FIG. 3 shows the relationship between s-wave polarized emissivity and emission angles.

FIG. 4 is a block diagram explaining a second basic principle of radiation thermometry and a radiation thermometry system according to the first example of the invention.

FIG. 5 is a schematic view showing a specific configuration of the radiation thermometry system of the first example.

FIG. 6 is a flowchart for calculating temperatures of thin-films in the radiation thermometry system of the first example.

FIG. 7 is a schematic view showing a specific radiation thermometry system according to a third example of the invention.

FIG. 8 is a schematic view showing a specific configuration of a hybrid surface temperature sensor assembled in the radiation thermometry system in the third example.

### DESCRIPTION OF EXAMPLES

The invention will be described with reference to the accompanying drawings. In the drawings, like or corresponding parts are denoted by like or corresponding reference numerals. The drawings are schematic, and shapes of some components may differ from those of actual components. Further, scales or dimensions may differ in drawings.

The following describe a specific method and a system for carrying out the technical concept of the invention, and are not to be construed as limiting arrangements of components. Various modifications and alterations could be made to the invention without departing from the scope of the invention.

The invention has been contemplated on the basis of the fact discovered in the basic researches conducted by researchers including the present inventor. Specifically, the emissivity invariant condition is existent because of polarization even when thermal radiation is produced by thin-films on a substrate.

### Example 1

[First Basic Principle]

In a first example, radiation thermometry and a radiation thermometry system are based on the following first basic principle.

Referring to FIG. 1, a first basic configuration comprises: a substrate 1; a thin-film 2 on the substrate 1; a radiometer 4 disposed in a direction EA above the thin-film 2 in order to measure polarized radiance components emitted from the thin-film 2, the direction EA being within a minute angle θ eic where the emissivity of the polarized radiance components does not vary; and a polarization element 3 disposed above the thin-film 2 and in the direction EA above the thin-film 2, and transmits polarized radiance components of thermal radiation.

The substrate 1 is a silicon (Si) substrate, for instance, and may be in a state of a wafer used in preprocessing of a semiconductor fabricating process, or in a state of a chip used for post processing. In the first example, the thin-film 2 may be a silicon series insulating film, specifically a silicon oxide film (SiO₂), which may be made by the thermal oxidation, CVD, or silicon oxidation. Further, the thin-film 2 may be being made or may have been made. Still further, the substrate 1 having the thin-film 2 thereon is sometimes referred to as a thin-film substrate.

The expression “angle θ eic where the emissivity of the polarized radiance components remains invariable” is defined not only by the planar normal line N_{L} which is perpendicular to the surface of the thin-film 2 or of the thin-film substrate, but also by a radiation direction E_{A} which is inclined toward the surface of the thin-film 2 with respect to the planar normal line N_{L}. A virtual plane including the planar normal line N_{L} and the radiation direction E_{A} is defined as a radiation plane S_{E}. The angle θ eic will be described later in detail.

The polarization element 3 receives light thermally radiated from the surface of the thin-film 2 (mainly visible light and infrared light), extracts polarized radiance components from the received light, and outputs them to the radiometer 4. In this case, the polarization element 3 extracts p-wave polarized radiance components (parallel polarized waves). The p-wave polarized radiance components are electric components which are parallel to the radiation plane S_{E}. In other words, the p-wave polarized radiance components have a vibrating surface of an electric field which matches with the radiation plane S_{E}.

The radiometer 4 receives the p-wave polarized radiance components extracted via the polarization element 3, and produces and outputs an electric signal in response to the received components. In short, the radiometer 4 may be an optical sensor or a photoelectric transducer of any kind. In this example, the radiometer 4 is designed to operate in a light receiving wavelength range where the substrate 1 becomes opaque at a film making temperature of 800 K or higher for the thin-film 2, for instance. With a silicon semiconductor, the wavelength range is a short wavelength range of 0.9 μm or less which corresponds to energy larger than band gap energy. Further, it is known that the higher the temperature, the more extensively the wavelength range shifts to a long wavelength range where the substrate 1 becomes opaque.

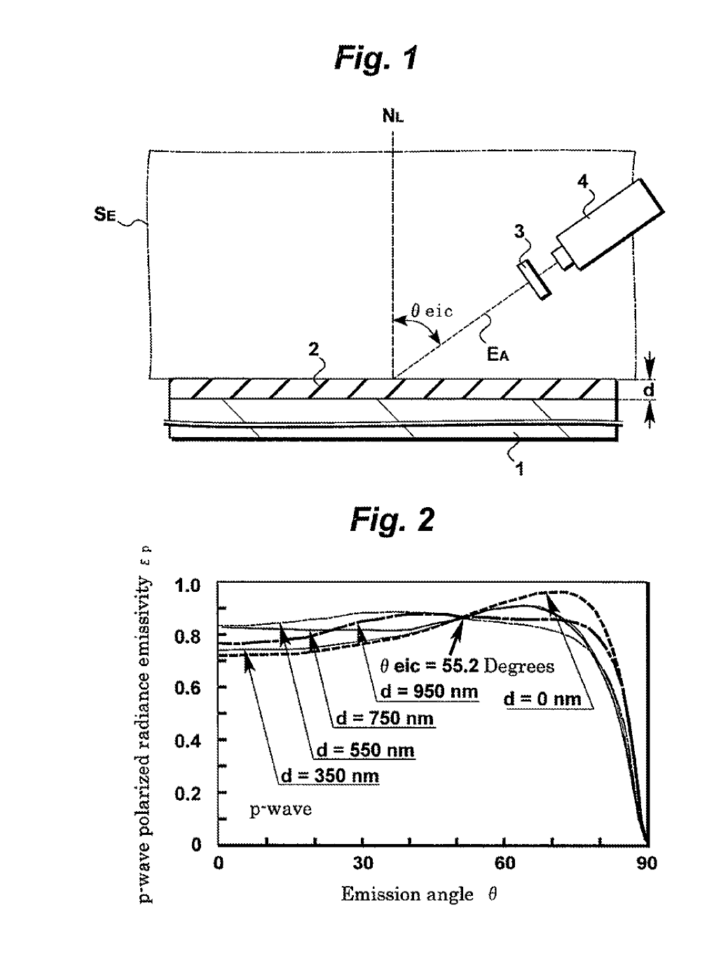

FIG. 2 shows the relationship between the p-wave polarized emissivity and radiation angles when the wavelength is 0.9 μm in the thin-film 2 Data shown in FIG. 2 have been actually measured by the inventor. In FIG. 2, the ordinate denotes the p-wave polarized radiance ε ₚ while the abscissa denotes the radiation angle θ. A silicon substrates is utilized as a specimen, and a silicon oxide film is utilized as the thin-film 2. Five kinds of thin-films 2 having different thicknesses are prepared on the substrate 1. Each of the thin-films 2 is 0 nm thick (when the substrate 1 is exposed, without the thin-film), 350 nm, 550 um, 750 nm and 950 nm thick.

As shown in FIG. 2, the p-wave polarized emissivity becomes constant irrespective of thicknesses d of the thin-film 2 within an angle range of 55 degrees a ±2 degree margin (specifically, 55.2 degrees) with respect to the planar normal line NL_{L}. In short, curves denoting the p-wave polarized emissivity within the angle range of 0 degrees to 90 degrees of the thin-film 2 (with the respective thicknesses d) are focused on one point in the angle range of 53 degrees to 57 degrees. The phenomenon is caused by the Brewster angle between the thin-film 2 and the atmosphere (or vacuum). In this example, the angle range of 53 to 57 degrees is within the angle θ eic at which p-wave polarized emissivity does not vary. According to the further experiments conducted by the inventor, the p-wave polarized emissivity has been confirmed to remain constant with the angle range of 53 degrees to 57 degrees irrespective of temperature variations.

In other words, it is possible to design the radiation thermometry and the radiation thermometry system which can precisely measure radiation temperatures of thin-films. In this case, behaviors of multiple reflection light in the thin-film 2 on the substrate 1 are utilized, which enables the p-wave polarized emissivity to become constant irrespective of the thicknesses d of the thin-film 2, and prevent variations of emissivity.

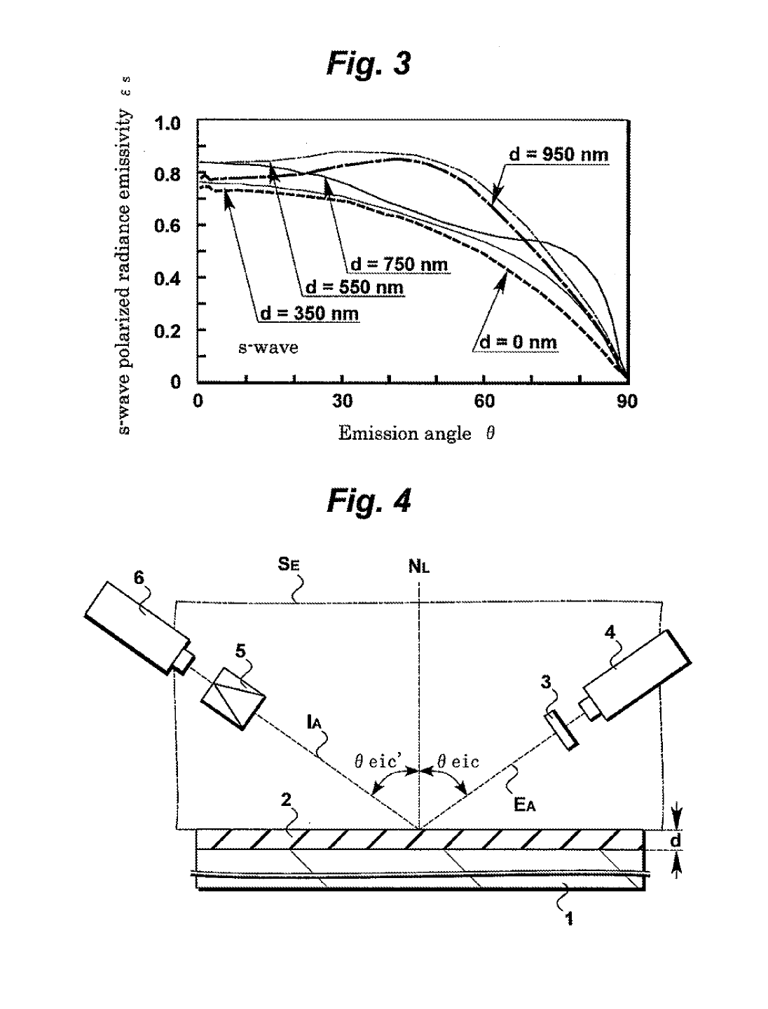

FIG. 3 shows the experimental relationship between an s-wave polarized wave (senkrecht polarized wave) emissivity and emission angles. The s-wave polarized radiance components are electric components which are perpendicular to the radiation surface S. In FIG. 3, the ordinate denotes the s-wave polarized radiance components while the abscissa denotes the emission angles θ. No phenomenon in which the s-wave polarized emissivity is constant irrespective of the thickness d of the thin-film 2 has been observed.

Temperatures of the thin-film 2 are calculated as follows on the basis of p-wave polarized radiance components measured by the radiometer 4. Refer to FIG. 1.

An output signal L₁ of the radiometer 4, which detects p-wave polarized radiance components within the angle θ eic where the emissivity remains invariable, is expressed by a formula (1).

[Formula 1]

L=εₚ(θ eic)·L_{λ·b}(T₁) (1)

In Formula 1, εₚ (θ eic) denotes the p-wave polarized emissivity at an angle (e.g. 55 degrees) where the emissivity remains invariable, and L_{λ·b} (T₁) is a spectral blackbody radiance of the thin-film 2 at the temperature T₁ and the wavelength λ. There is a one-to-one correspondence between T₁ and the L_{λ·b} (T₁) on the basis of Plank's blackbody radiance principle.

The formula 1 can be rewritten as a formula 2 by dividing the output signal L₁ of the formula 1 by well-known L_{λ·b} (T₁) so long as the p-wave polarized emissivity ε ₚ (θ eic) is constant.

[Formula 2]

L₁/εₚ(θ eic)=L_{λ·b}(T₁) (2)

In Formula 2, the right side denotes L_{λ·b} (T₁) at the temperature T₁. The temperature T₁ of the thin-film 2 can be precisely obtained by calculating back the Formula 2.

[Second Basic Principle]

An additional basic configuration becomes necessary when applying the radiation thermometry and radiation thermometry system of the first example to a semiconductor device fabricating process, for instance. A second basic principle for the second basic configuration will be described hereinafter.

Referring to FIG. 4, the second basic configuration includes the following in addition to the first basic configuration: a pseudo-blackbody 5 which absorbs and negates background radiations; and a temperature sensor 6 for measuring the pseudo-blackbody 5. The pseudo-blackbody 5 is positioned on an incident axis I_{A} which is symmetrical to the direction E_{A} within the angle θ eic where the emissivity of the polarized radiance components from the thin-film 2 on the substrate 1 remains invariable. The incident axis I_{A} has specular symmetry in the direction EA with the planar normal line N_{L} which is perpendicular to the surface of the thin-film 2 or the thin-film substrate.

The incident axis I_{A} has specular symmetry to the direction E_{A} with the planar normal line N_{L} at the center, and forms the angle θ eic of 53 to 57 degrees with the planar normal line N_{L}. On the radiance plane S_{E}, the angle formed by the incident shaft I_{A} and the direction E_{A} is equal to 2 θ eic.

The pseudo-blackbody 5 absorbs substantially all of the background radiations which are present around the pseudo-blackbody 5 on the incident axis I_{A}. For instance, heat treatment is carried out before depositing the thin-film 2 in the semiconductor device fabricating process. Thermal radiations from adjacent heat sources such lamps or the like for the heat treatment reflect on the surface of the thin-film 2 as background radiations (disturbance light), and are received by the radiometer 4. Since background radiations are very large compared with the radiations from the thin-film 2, temperature measuring errors are extensively caused.

In other words, the pseudo-blackbody 5 not only shields background radiations which pass over the incident shaft I_{A}, are reflected on the thin-film 2 and are received by the radiometer 4, but also emits light having constant radiations depending upon temperatures. In short, the pseudo-blackbody 5 completely absorbs light which is incident on the incident shaft I_{A} from outsides and has a variety of wavelengths, and emits light having predetermined radiance. The pseudo-blackbody 5 is preferably an alumina (Al₂O₃) ceramics group blackbody, a heat resistant semiconductor such as SiC, or an artificial graphite blackbody.

The temperature sensor 6 measures a temperature of the pseudo-blackbody 6, serves as a reference power source to produce a background temperature for detecting temperatures of the thin-film 2 by using the polarized radiance. The temperature sensor 6 may be preferably a radiometer different from the radiometer 4, a thermocouple temperature sensor, a fluorescent temperature sensor, or the like.

The following describe how temperatures of the thin-films 2 are calculated on the basis of the detected p-wave polarized radiance components, with reference to FIG. 4.

Within the angle range of θ eic where the emissivity remains invariable, the radiometer 4 produces an output signal L₂ expressed by Formula 3 in place of the output signal L₁ expressed by Formula 1.

[Formula 3]

L₂=εₚ(θ eic)·L_{λ·b}(T₁)+{1−εₚ(θ eic)}·L_{λ·b}(T₂) (3)

The first term of the right side, ε ₚ (θ eic)·L_{λ·b} (T₁), denotes a spectral emissivity radiance (at the temperature T₁) emitted by the thin-film 2 in accordance with the p-wave polarized radiance at the temperature T at the angle (e.g. 55 degrees) where the radiance of the thin-film 2 remains invariable. The second term, {1−ε ₚ (θ eic)}·L_{λ·b} (T₂)}, denotes a radiance component of the spectral blackbody radiance L_{λ·b} (T₂) which is emitted from the blackbody 5, is reflected on the surface of the thin-film 2, and is detected by the radiometer 4 at a rate of 1−εₚ (θ eic).

In Formula 3, both of ε ₚ (θ eic) and {1−ε ₚ (0 eic)} are constant. The temperature T₂ has been measured by the temperature sensor 6. Since {1−εₚ (θ eic)}·L_{λ·b} (T₂)} is known, Formula 3 can be rewritten as Formula 4.

[Formula 4]

{L₂−{1−εₚ(θ eic)}·L_{λ·b}(T₂)}/εₚ(θ eic)=L_{λ·b}(T₁) (4)

In Formula 4, the right side denotes the spectral blackbody radiance L_{λ·b} (T₁) at the temperature T₁. The temperature T₁ of the thin-film 2 can be derived by calculating the left side of Formula 4 with influences of background radiation removed. Based on the second basic principle, it is possible to avoid not only variations of the emissivity but also influences of the background radiations, and to precisely measure radiation temperatures by using the condition that the emissivity of the p-polarized radiance is kept constant irrespective of the thickness d of the thin-film 2 The invention can provide the radiation thermometry and radiation thermometry system satisfying the foregoing requirements.

[Radiation Thermometry System and Radiation Thermometry]

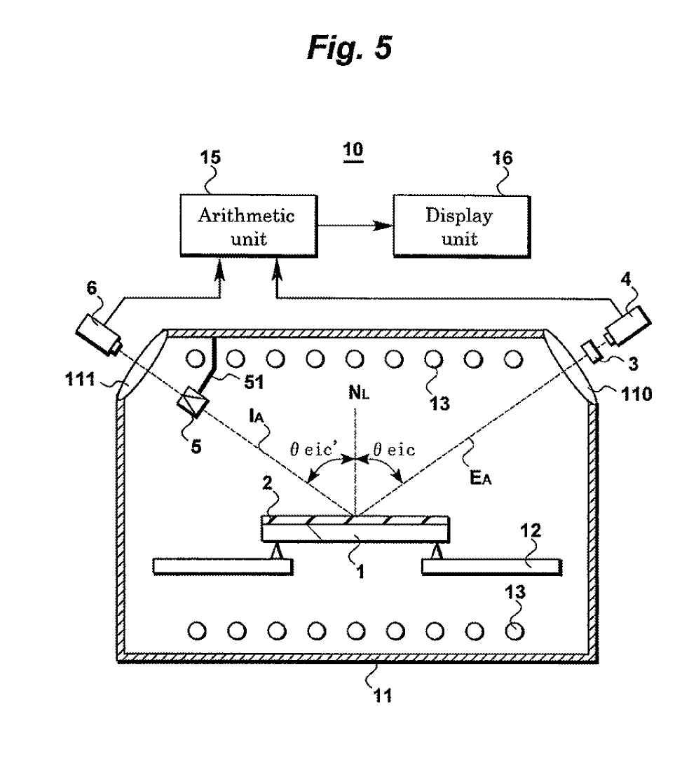

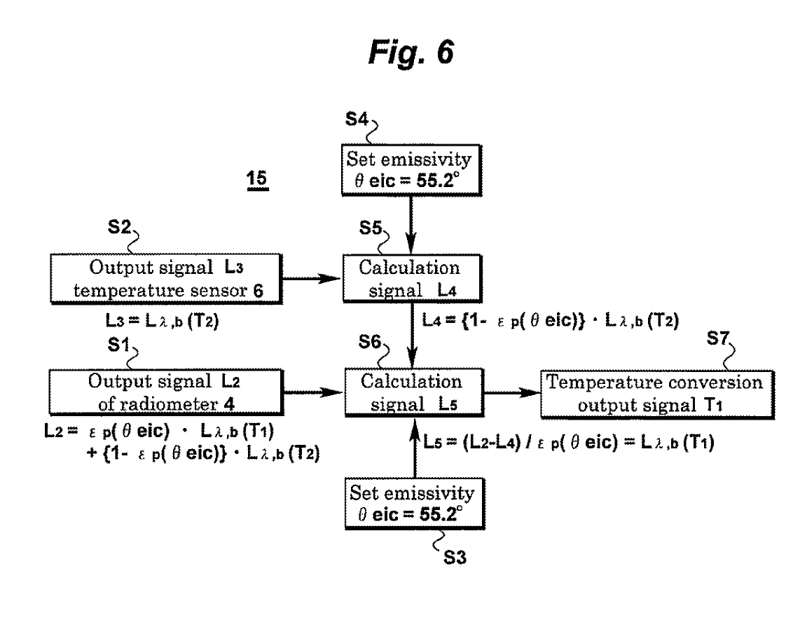

A specific configuration of a radiation thermometry system 10 of the first example will be described hereinafter. Referring to FIG. 5, the radiation thermometry system 10 comprises a pseudo-blackbody 5, a temperature sensor 6, a radiometer 4, and an arithmetic unit 15. The pseudo-blackbody 5 is disposed on an incident axis I_{A} which is mirror symmetrical to the emission direction E_{A} with respect to the planar normal line N_{L} , perpendicular to the surface of the thin-film 2, and absorbs and negates background radiations. The emission direction E_{A} is at the angle θ eic where the emissivity of first polarized radiance components from the thin-film 2 remains invariable. The temperature sensor 6 measures a temperature T₂ of the pseudo-blackbody 5. The radiometer 4 measures both the first polarized radiance components, and second polarized radiance components which are emitted onto the incident axis I_{A} from the pseudo-blackbody 5 and reflected on the surface of the thin-film 2 The arithmetic unit 15 calculates the temperature T₁ of the thin-film 2 on the basis of the measured first and second polarized radiation components and the temperature T₂ measured by the temperature sensor 6.

Further, the radiation thermometry system 10 includes: a chamber 11 housing the substrate 1 and filled with air or kept in a vacuum; a plurality of heating sources 13 heating the substrate 1; a polarization element 3 positioned between the thin-film 2 on the substrate 1 and the radiometer 4, and extracting polarized components from thermal radiations from the thin-film 2; and a display unit 16 showing the temperature T₁ of the thin-film 2 calculated by the arithmetic unit 15.

In the chamber 11, the substrate 1 is held on a quartz support 12 or the like in a removable state. The heaters 13 are provided at positions facing front and rear surfaces (shown at upper and lower parts in FIG. 5) of the substrate. 1 housed in the chamber 11. In this example, the heating sources 13 are preferably infrared lamps like halogen lamps and so on.

The chamber 11 has an opening 110 via which light emitted by the thin-film 2 is transmitted. The opening 110 is positioned in the direction E_{A} within the angle θ eic where the emissivity of the first polarized radiance components (p-wave polarized radiance components) from the thin-film 2 on the substrate 1 remains invariable. Further, the polarization element 3 and radiometer 4 are disposed near an outer surface of the housing and near the opening 110 in the direction E_{A}. The radiometer 4 is connected to the arithmetic unit 15, and sends an output signal to the arithmetic unit 15.

In the chamber 11, the pseudo-blackbody 5 is provided on the incident axis I_{A} which is mirror symmetrical to the direction E_{A}. The pseudo-blackbody 5 is fixed using a support 51. Further, an opening 111 is positioned in the direction E_{A}, and transmits thermal radiation from the pseudo-blackbody 5. The temperature sensor 6 is positioned on the incident axis I_{A} and near the opening 111, and is connected to the arithmetic unit 15 in order to send the output signal thereto.

The arithmetic unit 15 carries out operations shown in FIG. 6, and calculates the temperature T₁ of the thin-film 2 on the basis of the output signal L₂ of the radiometer 4, and the output signal 14 of the temperature sensor 6. The arithmetic operations are executed as described hereinafter.

In step S1 (the term “step” omitted hereinafter), the radiometer 4 of the radiation thermometry system 10 sends the output signal L₂ to the arithmetic unit 15. Further, the temperature sensor 6 sends the output signal L₃ to the arithmetic unit 15 (S2). The output signal may be sent first and the output signal L₃ may be sent after the output signal L2, or vice versa. Further, they may be sent at the same time. In the direction E_{A}, within the angle θ eic where emissivity remains invariable, the radiometer 4 receives not only the p-wave polarized radiance components (the first polarized radiance components) which have been emitted from the thin-film 2 and have been extracted by the polarization element 3 but also the p-wave polarized radiance components (second polarized radiance components) which have been emitted from the pseudo-blackbody 5 and have been extracted by the polarization element 3. The radiometer 4 converts the received signals into electric signals, and sends them as the output signals L₂. The output signal L₃ represents temperature information (thermal radiation components) which has been emitted by the pseudo-blackbody 5, and is measured and is converted into an electric signal by the temperature sensor 6.

The arithmetic unit 15 sets out the emissivity of the p-wave polarized radiance components in response to the output signal L₂ from the radiometer 4 (S3). The emissivity is constant since the radiometer 4 is positioned in the direction E_{A} within the angle θ eic. The arithmetic unit 15 sets up the emissivity in response to the output signal L₃ from the temperature sensor 6 (S4).

The arithmetic unit 15 produces a calculation signal L₄ in response to the output signal L₃ of the temperature sensor 6 and the set emissivity (S5). The calculation signal L₄ represents spectral blackbody radiance components of the pseudo-blackbody 5 at the temperature T₂ reflected by the thin-film 2 and measured by the radiometer 4. Further, the arithmetic unit 15 produces an output signal L₅ on the basis of the output signal L₂ of the radiometer 4, the set emissivity and the calculation signal L₄ (S6). The calculation signal L₆ represents the spectral blackbody radiance of the thin-film 2 at the temperature T₁ in Formula (4). The arithmetic unit 15 sends the calculation signal L₅ to the display unit 16 as a temperature conversion output signal T₁ (S7).

The display unit 16 digitally or analogously indicates the temperature conversion output signal T₁. The display unit 16 may be preferably a temperature display, a display connected to a personal computer, a printer numerically and directly printing temperatures, or the like.

So long as the emissivity remains invariable, the foregoing radiation thermometry system 10 and radiation thermometry are effective in measuring the temperature T₁ of the thin-film 2 irrespective of variations of thickness d of thin-film 2 on the substrate 1 and the film making temperature T₁ of the thin-film 2.

Further in the first example, the pseudo-blackbody 5 is positioned on the incident axis I_{A} which is mirror symmetrical to the emitting direction E_{A}. The pseudo-blackbody 5 absorbs and negates the background radiations to the radiometer 4. This is extensively effective in measuring the temperature T₁ of the thin-film 2 in the non-contact state.

Still further in the first example, the temperature T₂ of the pseudo-blackbody 5 is measured. The measured result is applicable as a reference for the polarized radiance components, which is effective in more precisely measuring the temperature T₁ of the thin-film 2 in the non-contact state.

### Example 2

A second example of the invention relates to a modified example of a thin-film substrate of the first example.

In the first example, the substrate 1 includes the silicon oxide thin-film 2 Alternatively, the thin-film 2 may be a silicon group insulating thin-film such as a silicon nitride film or an oxynitride group insulating thin-film Such thin-films have an angle range in which the emissivity remains constant. In the second example, the foregoing thin-films are applied as the thin-film 2 The temperature of the thin-film 2 can be measured using the radiation thermometry system 10 and radiation thermometry.

To be more specific, with the silicon oxide thin-film, p-wave polarized radiance components are measured within an angle range 61 degrees to 65 degrees when the center angle with respect to the normal line of the thin-film substrate is 63 degrees. Further, with the silicon oxynitride thin-film, p-wave polarized radiance components are measured within an angle range 55 degrees to 59 degrees when the center angle with respect to the normal line of the thin-film substrate is 57 degrees.

The radiation thermometry system 10 and the radiation thermometry of the second example are as advantageous as those of the first example.

### Example 3

In a third example, a hybrid surface temperature measuring system and hybrid radiation thermometry are incorporated into the radiation thermometry system 10 and the radiation thermometry according to the first or second example.

[Configuration of Radiation Thermometry System]

In this example, the radiation thermometry system 10 (shown in FIG. 3) is provided with the hybrid surface temperature measuring system 30, which includes a contact sensor 31, a radiance sensor 32, and a drive control unit 33.

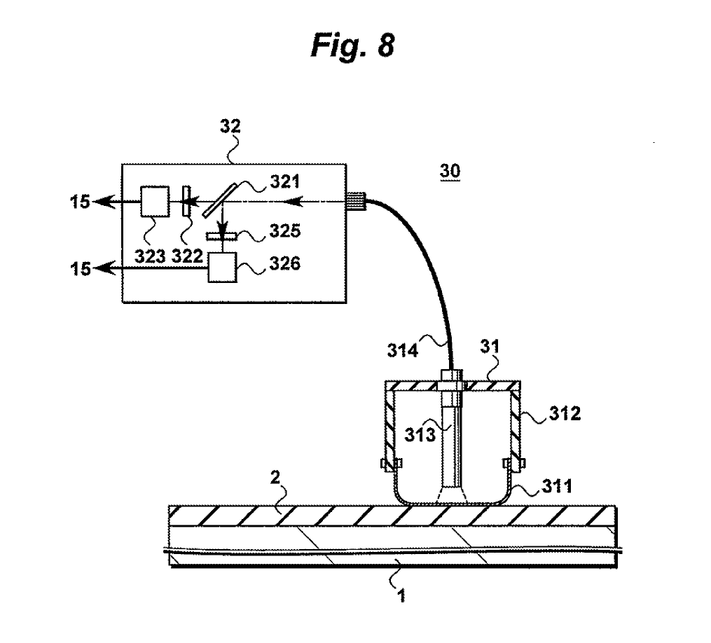

Referring to FIG. 8, the contact sensor 31 includes: a thin-film contact shoe (a front edge of the contact sensor 31) 311 which is brought into contact with the surface of the thin-film 2 with an appropriate pressure; a support 312 holding the thin-film contact shoe 311 and having good heat insulating properties not to thermally affect the thin-film contact shoe 311; and a transmitter 313 disposed with a space from a rear surface of the thin-film contact shoe 311, and transmitting radiance components from the rear surface of the thin-film contact shoe 311 with a minimum transmission loss. Further, the contact sensor 31 includes a cable 314 connecting to the radiance sensor 32.

The thin-film contact shoe 311 is constituted by a material which can quickly accomplish thermal balance when brought into contact with the thin-film 2 to be measured, and is a thin-film or a thin metal plate. The thin-film or thin metal plate is rectangular, and is 3 mm to 7 mm wide and 15 mm to 20 mm long, for instance. Further, the thin-film contact shoe 311 is 3 μm to 30 μm thick in order to establish the thermal balance between its front and rear surfaces, for instance. Therefore, it is possible to perform temperature measurements at an accelerated speed of one second or shorter. The thin-film contact shoe 311 is made of base metal such as hastelloy, aluminum, stainless steel, Inconel, titanium and tungsten, an alloy of the foregoing base metal, or precious metal such as gold, platinum, and iridium. Further, the thin-film contact shoe 311 may be a silicon thin-film. In such a case, the silicon thin-film is the same as the silicon substrate 1. Further, when the thin-film 2 is a silicon oxide film, the thin-film contact shoe 311 has the same material. Therefore, the silicon thin-film is ideal as the thin-film contact shoe 311. The material of the thin-film contact shoe 311 is selected mainly in view of a temperature range to be measured and a fabricating cost.

The thin-film contact shoe 311 of the contact sensor 31 is brought into pressure contact with the surface of the thin-film 2 with pressure of 5×10³ Pa or higher, for instance, in order to reduce thermal contact resistance and improve thermometry.

The support 312 is made of two quartz plates (for instance), which are placed with the transmitter 313 at the center. The two quartz plates are respectively connected to opposite ends of the thin-film contact shoe 311. Further, the support 312 may be made of ceramics having excellent heat resisting properties.

In the third example, the transmitter 313 is a thin and long cylinder, and transmits, via a narrow space thereof, radiance from the rear surface of the thin-film contact shoe 311 to the cable 314 with minimum transmission loss. The transmitter 313 may be a sapphire rod having a diameter of 1.1 mm to 1.5 mm. Alternatively, the transmitter 313 may be a quartz rod, a calcium fluoride (CaF₂) rod, a barium fluoride (BaF₂) rod or the like. One end of the transmitter 313 faces the rear surface of the thin-film contact shoe 311 while the other end thereof is connected to the cable 314. There is a 1 mm space between the one end of the transmitter 313 and the rear surface of the thin-film contact shoe 311, for instance. The cable 314 is an optical fiber cable, for instance.

The radiance components from the rear surface of the thin-film contact shoe 311 of the contact sensor 31 are input to the radiance sensor 32 via the transmitter 313 and the cable 314. In this example, the radiance senor 32 includes: a first measuring sensor 323 which receives radiance components via a half mirror 321 and a first filer 322; and a second measuring sensor 326 which receives the radiance components reflected by the half mirror 321 and transmitted via a second filter (long pass filter) 325. The first measuring sensor 323 may be an Si sensor having excellent sensitivity in a high temperature range while the second measuring sensor 326 may be an InGaAs sensor having excellent sensitivity in a low temperature range. In short, the radiance sensor 32 is a compound sensor having the first and second measuring sensors 323 and 326.

The drive control unit 33 includes a driver system and a control system controlling the driver system (not shown), both of which are disposed outside the chamber 11. The driver system and control system of the drive control unit 33 are connected to the contact sensor 31 housed in the chamber 11. When measuring temperatures, the drive control unit 33 brings the thin-film contact shoe 311 of the contact sensor 31 into pressure contact with the surface of the thin—film 2 of the thin—film substrate. When no measurement is performed, the drive control unit 33 keeps the thin-film contact shoe 311 out of contact with the surface of the thin-film 2 of thin-film substrate.

The contact sensor 31 of the hybrid surface temperature sensor system 30 brings the thin-film contact shoe 311 into contact with the surface of the thin-film 2 of the thin-film substrate. The contact sensor 31 outputs the radiance components from the rear surface of the thin-film contact shoe 311 to the radiance sensor 32 via the transmitter 313 and the cable 314. The radiance sensor 32 produces an electric signal in accordance with the radiance components which are inputted via the cable 314, and first and second measuring sensors 323 and 326. The electric signal is sent to the arithmetic unit 15, so that a surface temperature of the thin-film 2 will be determined.

According to the third example, the hybrid surface temperature sensor system 30 allows precise and quick temperature measurement of the thin-film 2 simply by bringing the contact sensor 31 into contact with the surface of the thin-film 2 It is not necessary to weld a thermocouple to the thin-film 2 or to apply a black tape or black paint onto the thin-film 2 whose temperature is to be measured. Therefore, the temperature measurement of wafers or thin-films on wafers can be efficiently carried out in a semiconductor fabricating process.

[Radiation Thermometry]

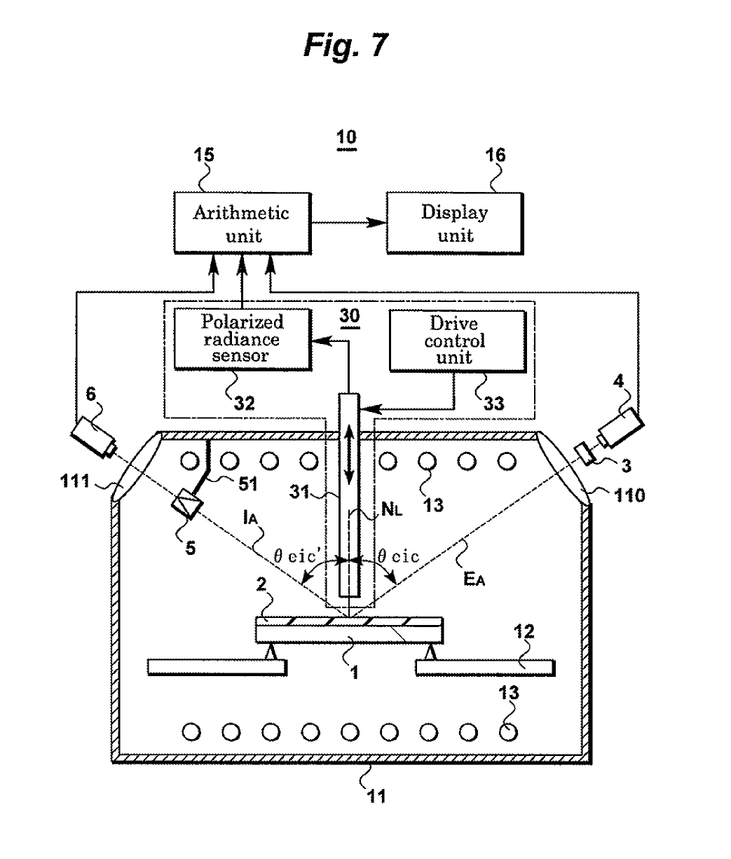

Referring to FIG. 7 and FIG. 8, the radiation thermometry of the third example will be will be described hereinafter. First of all, a surface temperature of the thin-film 2 of the thin-film substrate in the chamber 11 of the radiation thermometry system 10 is measured, in the off-line mode, by the hybrid surface temperature measuring system 30. The contact sensor 31 (of the hybrid surface temperature measuring system 30) is moved in the chamber 11 by the drive control unit 33, so that the thin-film contact shoe 311 comes into contact with the surface of the thin-film 2 of the thin-film substrate. When contacted with the thin-film 2, the thin-film contact shoe 311 becomes thermally balanced, and emits radiance components from its rear surface. The radiance components are sent to the radiance sensor 32 via the transmitter 313 of the contact sensor 31, and via the cable 314. The radiance sensor 32 measures the surface temperature of the thin-film 2 on the basis of the received radiance components, and sends the measured results to the arithmetic unit 15. The arithmetic unit 15 calculates the surface temperature of the thin-film 2 based on the measured results from the radiance sensor 32, so that the calculated surface temperature is shown on the display unit 16 as the surface temperature.

Next, in the off-line mode, the temperature of the thin-film 2 of the thin-film substrate will be measured using the radiation thermometry according to the first example, and will be shown on the display unit 16.

It is checked whether or not the temperature of the thin-film 2 measured by the radiation thermometry according to the first example is within a tolerance range of the temperature of the thin-film 2 measured by the hybrid surface temperature measuring system 30. When the temperature measured by the radiation thermometry is equal to the temperature measured by the hybrid surface temperature measuring system 30 within the tolerance range, the temperature by the radiation thermometry is proved to be correct.

The temperatures of the thin-film 2 of the thin-film substrate will be measured in the in-line mode at any time in accordance with the proved results into consideration.

As described so far, the hybrid surface temperature measuring system 30 is used for calibration in the third example, and is applicable to activating the radiation thermometry system 10 and the radiation thermometry, and to measuring reference temperatures when new materials are utilized. In accordance with the reference temperatures, the radiation thermometry system 10 will be actuated, and the radiation thermometry will be executed. This is effective in precisely carrying out temperature measurements.

With the radiation thermometry of the third example, the temperature measurement according to the radio thermometry may be performed prior to the hybrid surface temperature measurement using the hybrid surface temperature measuring system 30. Alternatively, the radiation thermometry may be conducted first according to the first example.

### Other Example

The invention has been described by means of the first example, but is not limited thereto. The invention will undergo various modifications and alterations.

The invention is not limited to silicon substrates, and is widely applicable to various kinds of substrates on which thin-films are made in popular semiconductor device fabricating processes. In such a case, the angle θ eic which is the emissivity invariant condition will generally vary with kinds of semiconductors.

### INDUSTRIAL APPLICABILITY

The invention is widely applicable to radiation thermometry and radiation thermometry which can precisely measure temperatures of a thin-film on a substrate in non-contact state.

1. Radiation thermometry comprising:
depositing a thin-film on a substrate and making a thin-film substrate;
measuring polarized radiance components emitted from the thin-film substrate in a direction which is within an angle range, from a planar normal line of the thin-film substrate, where radiance components remain invariable; and
calculating a temperature of the thin-film substrate on the basis of the measured results of the polarized radiance components.

2. The radiation thermometry defined in claim 1, wherein the polarized radiance components are measured by measuring p-wave polarized radiance components which are parallel to an emitting surface including a direction where the polarized radiance components are measured.

3. The radiation thermometry defined in claim 1, wherein the polarized radiance components are measured in a wavelength range where the thin-film substrate becomes opaque.

4. The radiation thermometry defined in claim 2, wherein the thin-film substrate is made by depositing a silicon oxide thin-film on the substrate, and the p-wave polarized radiance components are measured when p-wave polarized radiance components are present at an angle of 53 degrees to 57 degrees with respect to a normal line of the silicon oxide thin-film substrate, the center angle being 55 degrees.

5. The radiation thermometry defined in claim 2, wherein the thin-film substrate is made by depositing a silicon nitride thin-film on the substrate, and the p-wave polarized radiance components are measured when p-wave polarized radiance components are present at an angle of 61 degrees to 65 degrees with respect to a normal line of the silicon nitride thin-film substrate, the center angle being 63 degrees.

6. The radiation thermometry defined in claim 2, wherein the thin-film substrate is made by depositing a silicon oxynitride thin-film on the substrate, and the p-wave polarized radiance components are measured when p-wave polarized radiance components are present at an angle of 55 degrees to 59 degrees with respect to a normal line of the silicon oxynitride thin-film substrate, the center angle being 57 degrees.

7. Radiation thermometry comprising:
depositing a thin-film on a substrate and making a thin-film substrate;
disposing a pseudo-blackbody on an incident axis in an emitting direction where emissivity of first polarized radiance components emitted by the thin-film substrate do not vary at an angle which is mirror-symmetrical to the normal line of the surface of the thin-film substrate, and measuring temperatures of the pseudo-blackbody, the pseudo-blackbody absorbing and negating background radiations and emitting constant radiance components;
measuring not only the first polarized radiance components but also second polarized radiance components emitted from the pseudo-blackbody onto the incident axis and reflected on the surface of the thin-film substrate, the second polarized radiance components being advanced in the emitting direction: and
calculating a temperature of the thin-film substrate on the basis of the measured first and second polarized radiance components and the temperature of the pseudo-blackbody.

8. The radiation thermometry defined in claim 1, further comprising:
contacting a thin-film contact shoe with the surface of the thin-film substrate, and
measuring radiance emitted from front and rear surfaces of the thin-film contact shoe; and
measuring a surface temperature of the thin-film substrate on the basis of the measured polarized radiance components.

9. The radiation thermometry defined in claim 8, wherein after a first process in which the surface temperature of the thin-film substrate is measured on the basis of radiance emitted from the rear surface of the thin-film contact shoe, and a second process in which the polarized radiance components or the first polarized components are measured within an angle where the emissivity remains invariable from the normal line of the thin-film substrate, and calculating a temperature of the thin-film substrate on the basis of the measured results;
determining whether or not the temperature of the thin-film substrate in the first process is within a tolerance range of the measured results when compared with the surface temperature in the second process; and
using the second process for the measurement of the surface temperature of the thin-film substrate when the measured value is in the tolerance range.

10. A radiation thermometry system comprising:
a radiometer measuring polarized radiance components; which are emitted from a thin-film substrate within an angle range where emissivity remains invariable, the thin-film substrate having a thin-film on a surface thereof, and
an arithmetic unit calculating a temperature of the thin-film substrate on the basis of the polarized radiance components measured by the radiometer.

11. The radiation thermometry system defined in claim 10 further comprising:
a chamber housing the thin-film substrate therein;
a heat sources heating the thin-film substrate; and
a polarization element disposed between the thin-film substrate and the radiometer, and extracting polarized radiance components emitted by the thin-film substrate.

12. A radiation thermometry system comprising:
a pseudo blackbody disposed on an incident axis in an emitting direction at an angle where emissivity of first polarized radiance components emitted by the thin-film substrate do not vary, wherein the pseudo blackbody absorbs and negates background radiations, and emits constant radiance components, and the incident axis is mirror-symmetrical to the normal line of the surface of the thin-film substrate;
a temperature sensor measuring temperatures of the pseudo-blackbody;
a radiometer disposed in the emitting direction and measuring not only the first polarized radiance components but also second polarized radiance components emitted from the pseudo-blackbody onto the incident axis and reflected on the surface of the thin-film substrate, the second polarized radiance components being advanced in the emitting direction; and
an arithmetic unit calculating a temperature of the thin-film substrate on the basis of the measured first and second polarized radiance components and the temperature of the pseudo-blackbody.

13. The radiation thermometry system defined in claim 10 further comprising:
a contact sensor having a contact thin-film contact shoe brought into contact with a surface of the thin-film substrate; and
a sensor measuring polarized radiance components emitted from a rear surface of the thin-film contact shoe of the contact sensor, and sending measured results to the arithmetic unit.

14. The radiation thermometry defined in claim 7, further comprising:
contacting a thin-film contact shoe with the surface of the thin-film substrate, and
measuring radiance emitted from front and rear surfaces of the thin-film contact shoe; and
measuring a surface temperature of the thin-film substrate on the basis of the measured polarized radiance components.

15. The radiation thermometry system defined in claim 12 further comprising:
a contact sensor having a contact thin-film contact shoe brought into contact with a surface of the thin-film substrate; and
a sensor measuring polarized radiance components emitted from a rear surface of the thin-film contact shoe of the contact sensor, and sending measured results to the arithmetic unit.
